(19) United States
(12) Patent Application Publication
(10) Pub. No.: US 2014/0067534 A1
(43) Pub. Date: Mar. 6, 2014

(54) Method and System for Generating Commercial Information in Response to a Query

(71) Applicants: Stephen Wolfram, Champaign, IL (US); Russell Foltz-Smith, Austin, TX (US)

(72) Inventors: Stephen Wolfram, Champaign, IL (US); Russell Foltz-Smith, Austin, TX (US)

(73) Assignee: WOLFRAM ALPHA LLC, Champaign, IL (US)

(21) Appl. No.: 13/598,601

(22) Filed: Aug. 29, 2012

(51) Int. Cl. G06Q 30/02

(52) U.S. Cl. 705/14.54

(57) ABSTRACT

In a method for providing to a user commercial information regarding at least one of a product or a service, at least one of 1) a query of the user, or 2) an answer to the query is analyzed, and an activity of the user is inferred based on the analysis of the query and/or the answer. A general product or service to support the activity is determined, and a vendor that provides the general product or service is determined in response to determining the general product or service. Information regarding a specific product or service provided by the vendor is obtained, wherein the specific product or service corresponds to the general product or service. Commercial information corresponding to the specific product or service provided by the vendor is generated, wherein the commercial information is for electronic transmission to the user.

### TECHNICAL FIELD

This disclosure generally relates to a system that responds to user queries, and more particularly, to determining commercial information that may be of interest to a user based on the query and/or an answer to the query.

### BACKGROUND

Search engines, such as Internet search engines, have been in use for some time. Such search engines permit the user to form a search query using combinations of keywords to search through a web page database containing text indices associated with one or more distinct web pages. The search engine looks for matches between the search query and text indices in the web page database, and then returns a number of hits which correspond to URL pointers and text excerpts from the web pages that represent the closest matches.

Some Internet search engines analyze the context of keywords in order to narrow the number of matches. For example, if a search query includes the words “yellow” and “pages,” a search engine may recognize that the phrase “yellow pages” has a particular meaning and it may therefore note that web pages including the phrase “yellow pages” may be a closer match than web pages merely containing the word “yellow” and/or the word “pages.”

If a search query includes terms that correspond to a commercial product, the Internet search engine may return URL pointers to web pages of vendors, and such web pages may include information about the commercial product, such as pricing information, and links to enable a user to purchase the product via the vendor.

Similarly, some vendor websites have a search function that enables a user to search for key words on the website. The search function may return URL pointers to web pages of the website, and such web pages may include information about commercial products, such as pricing information, and links to enable a user to purchase products via the website.

### SUMMARY OF THE DISCLOSURE

In one embodiment, a method for providing to a user commercial information regarding at least one of a product or a service is implemented in a computing system. The method includes analyzing, using the computing system, a query of the user electronically received via a network, and inferring, using the computing system, an activity of the user based on the analysis of the query. The method also includes determining, using the computing system, a general product or service to support the activity, and determining, using the computing system and in response to determining the general product or service, a vendor that provides the general product or service. Additionally, the method includes electronically obtaining, using the computing system, information regarding a specific product or service provided by the vendor, wherein the specific product or service corresponds to the general product or service, and generating, using the computing system, commercial information corresponding to the specific product or service provided by the vendor, wherein the commercial information is for electronic transmission to the user.

In another embodiment, a system for providing product and/or service information to a user comprises a user modeling system. The user modeling system is configured to analyze a query of the user electronically received via a network, and infer an activity of the user based on the analysis of the query. Additionally, the user modeling system is configured to determine a general product or service to support the activity, anddetermine, in response to determining the general product or service, a vendor that provides the general product or service. The user modeling system is also configured to electronically obtain information regarding a specific product or service provided by the vendor, wherein the specific product or service corresponds to the general product or service, and generate commercial information corresponding to the specific product or service provided by the vendor, wherein the commercial information is for electronic transmission to the user.

In another embodiment, a computer readable storage medium has stored thereon machine executable instructions. The machine executable instructions are capable of causing, when executed by one or more processors, the one or more processors to analyze a query of the user electronically received via a network, and infer an activity of the user based on the analysis of the query. Also, the machine executable instructions are capable of causing, when executed by one or more processors, the one or more processors to determine a general product or service to support the activity, and determine, in response to determining the general product or service, a vendor that provides the general product or service. The machine executable instructions are capable of further causing, when executed by one or more processors, the one or more processors to electronically obtain information regarding a specific product or service provided by the vendor, wherein the specific product or service corresponds to the general product or service, and generate commercial information corresponding to the specific product or service provided by the vendor, wherein the commercial information is for electronic transmission to the user.

In yet another embodiment, a method for providing product and/or service information to a user is implemented in a computing system. The method includes analyzing, using the computing system, an answer to a query submitted to a query answering system, wherein the answer has been generated using the query answering computing system, and inferring, using the computing system, an activity of the user based on the analysis of the answer to the query. Additionally, the method includes determining, using the computing system, a general product or service to support the activity, and determining, using the computing system and in response to determining the general product or service, a vendor that provides the general product or service. The method also includes electronically obtaining, using the computing system, information regarding a specific product or service provided by the vendor, wherein the specific product or service corresponds to the general product or service, and generating, using the computing system, commercial information corresponding to the specific product or service provided by the vendor, wherein the commercial information is for electronic transmission to the user.

In still another embodiment, a system for providing product and/or service information to a user comprises a user modeling system. The user modeling system is configured to analyze an answer to a query submitted to a query answering system, wherein the answer has been generated using the query answering computing system, infer an activity of the user based on the analysis of the answer, determine a general product or service to support the activity, determine, in response to determining the general product or service, a vendor that provides the general product or service, electronically obtain information regarding a specific product or service provided by the vendor, wherein the specific product or service corresponds to the general product or service, and generate commercial information corresponding to the specific product or service provided by the vendor, wherein the commercial information is for electronic transmission to the user.

In another embodiment, a computer readable storage medium has stored thereon machine executable instructions. The machine executable instructions are capable of causing, when executed by one or more processors, the one or more processors to analyze an answer to a query submitted to a query answering system, wherein the answer has been generated using the query answering computing system, infer an activity of the user based on the analysis of the answer, determine a general product or service to support the activity, determine, in response to determining the general product or service, a vendor that provides the general product or service, electronically obtain information regarding a specific product or service provided by the vendor, wherein the specific product or service corresponds to the general product or service, and generate commercial information corresponding to the specific product or service provided by the vendor, wherein the commercial information is for electronic transmission to the user.

### BRIEF DESCRIPTION OF THE DRAWINGS

FIG. 1 is a diagram of an example system for answering natural language (NL) queries and providing commercial information regarding products/services related to NL queries and/or answers to NL queries, according to an embodiment;

FIG. 2 is a more detailed diagram of a portion of the system of FIG. 1, according to an embodiment; and

FIG. 3 is a flow diagram of an example method for providing commercial information regarding products/services related to an NL query, according to an embodiment.

### DETAILED DESCRIPTION

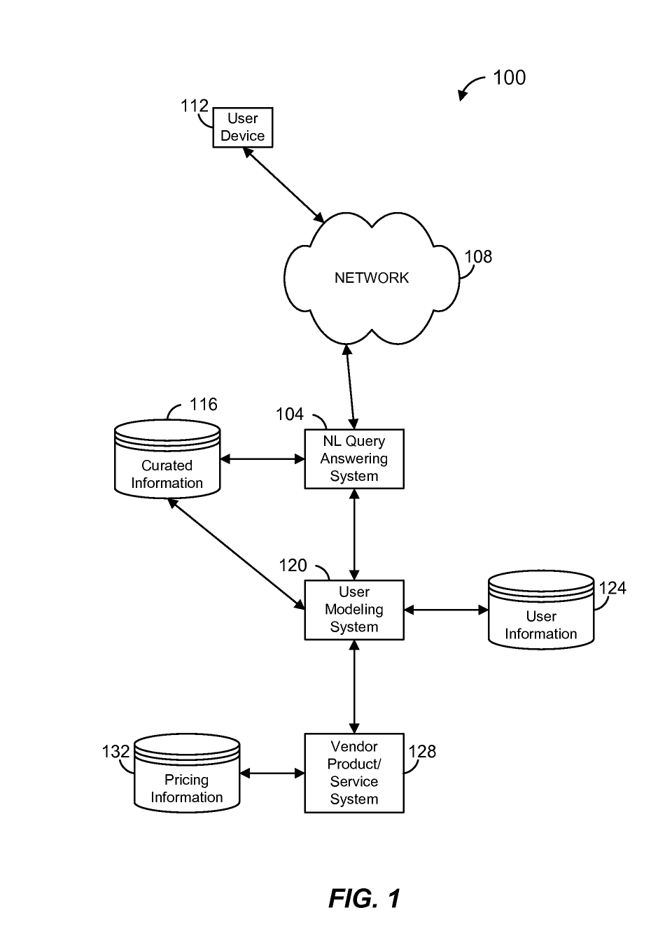

FIG. 1 is a diagram of an example system 100 for answering natural language (NL) queries and providing product/service information. An NL query answering system 104 is communicatively coupled to a communication network 108 such as the Internet, an intranet, etc. The NL query answering system 104 is configured to receive NL queries and to generate answers to the NL queries. The NL query answering system 104 generates answers to queries as opposed to merely providing links to web pages having words that match words in the query. In other words, the NL query answering system 104 attempts to understand the meaning of the query and then provides an answer to the query based on the understood meaning. In an embodiment, the NL query answering system 104 comprises a system the same as or similar to the systems described in U.S. patent application Ser. No. 11/852,044, filed on Sep. 7, 2007, and/or in U.S. patent application Ser. No. 12/780,685, filed on May 14, 2010, which are hereby incorporated by reference herein in their entireties.

A user device 112, which is a computing device such as a desktop computer, a gaming system, a tablet computer, a smart phone, etc., is also communicatively coupled to the communication network 108. A user submits a query to the NL query answering system 104 using the user device 112. For example, the user enters a query via the user device 112. For example, the user may enter a query via a web page or other display that is displayed on a display device of the user device 112. The user device 112 then transmits the query to the NL query answering system 104 via the network 108.

Each of the NL query answering system 104 and the user device 112 include respective network interfaces to transmit and receive data via the network 108.

The NL query answering system 104 is configured to analyze queries, and this analysis may be undertaken in a variety of ways in a variety of embodiments. In one embodiment, the terms of the natural language query may be identified and stored. Certain words may be eliminated such as “the” “a” and “an”. In addition, the NL query answering system 104 may understand plurals/singulars along with verb tenses, in some embodiments. Moreover, synonyms of natural language input terms may be used to better understand the query. Further, common misspellings may be noted and corrected. In some embodiments, the natural language terms may then be analyzed to determine if the inputted natural language terms match a previous natural language query. Still further, assumptions may be made when ambiguities arise. Additional information on how a natural language query input may be analyzed, in some embodiments, is found in U.S. patent application Ser. No. 11/852,044, filed on Sep. 7, 2007, U.S. patent application Ser. No. 12/780,685, filed on May 14, 2010, the entireties of which are hereby incorporated by reference.

In an embodiment, the NL query answering system 104 is able to recognize words and phrases that are stored in an entities database 116, which includes curated information regarding entities such as people, places, things, known scientific or mathematical formulas, etc. For example, the entities database 116 may comprise a structured database storing entities organized into categories, sub-categories, etc. In some embodiments, an entity can belong to multiple categories, sub-categories, etc. For example, a hamburger could be categorized as “Food” and also categorized as “Fast Food”, which is a sub-category of Food.

The NL query answering system 104 may determine how a term in the query is to be interpreted. As an example, the word “pi” can refer to different things, like the name of the well-known mathematical constant (7r) or the name of the movie “pi”. How the word “pi” is to be interpreted may, in some embodiments, be determined by the context in which it is used, such as by analyzing other terms in the query.

As another example, the letter “m”, standing alone or in combination with other characters such as “/” may refer to units of meters or minutes. The term “Meters” may be interpreted as a subtype of “Units”, and the terms “Units” and “Meters” may be associated in the database 116 to indicate that “Meters” is a subtype of “Units”. The term “m” could also be referring to units of minutes. The terms “Unit” and “Minutes” may be associated in the database 116 to indicate that “Minutes” is a subtype of “Units”.

As another example, a natural language query that contains the term “New York” may fit in the classification for a city. In addition, the term “New York” may fit into several classifications such as a state, a location, a book, a car and a type of steak. In some embodiments, the category is selected based on the context in which the term was used. As merely an example, if the term “New York” is included in a query that includes other city names, the term “New York” may be categorized as a city. On the other hand, if the term “New York” is included in a query that includes other state names, the term “New York” may be categorized as a state.

As another example, if a number is included in the query, the number may be interpreted as a velocity with units of miles per hour if a term “mph” is next to the number or the term “speed” is in the query. On the other hand, the number may be interpreted as a weight with units of pounds if a term “lb” or “pounds” is next to the number, or the term “weigh” or “weight” is in the query. U.S. patent application Ser. No. 11/852,044 and U.S. patent application Ser. No. 12/780,685 discuss techniques for determining categories with which terms may be associated and that may be utilized in some embodiments.

A user modeling system 120 is communicatively coupled to the NL query answering system 104. The user modeling system 120 is configured to model the user and to infer an activity of the user based on one or more of i) the query received by the NL query answering system 104, ii) the answer generated by the NL query answering system 104, or iii) user information stored in a user information database 124 coupled to the user modeling system 120. The user information may include information submitted by the user, information determined by the user modeling system 120, etc. Examples of user information include a location of the user, age, gender, prior queries submitted by the user, prior answers to prior queries submitted by the user, etc. User information may be associated with a user via a login identifier (e.g., for the NL query answering system 104 and/or the user modeling system 120), an email address, a mobile telephone number of the user device 112, an Internet Protocol (IP) address of the user device 112, a media access control (MAC) address of the user device 112, etc.

In some embodiments, at least some user information is additionally or alternatively received from the user device 112. For example, if the user device 112 is a smart phone with a global positioning system (GPS) receiver, location information of the user may be obtained from the user device 112, via the network 108, by the NL query answering system 104 and/or the user modeling system 120. For example, if the user device 112 is a smart phone, location information of the user may be obtained from the user device 112, via the network 108, by the NL query answering system 104 and/or the user modeling system 120.

In some embodiments, at least some user information is additionally or alternatively received from a service provider system, such as from a telephony service provider when the user device 112 is a smart phone, from a wireless data service provider when the user device 112 is a portable computing device having wireless network interface, etc. User information from a service provider system is received via the network 108, in some embodiments.

Modeling the user to infer the activity of the user includes recognizing the meaning of words in the query and utilizing context information, as opposed to merely determining that words in the query match words in a document or web page. In some embodiments, the modeling system 120 uses word meaning and/or context information determined by the NL query answering system 104.

For example, if the user enters a query such as “How long is the Crescent Ridge trail?”, the user modeling system 120 may infer that the user is going to hike on the Crescent Ridge trail. The inference may be made at least in part by, for example, recognizing that “Crescent Ridge trail” is a hiking trail, which recognition is made by the NL query answering system 104.

As another example, if the user enters a query such as “What is the distance between Chicago and Boston?”, the user modeling system 120 may infer that the user is going to go travel from Chicago, Ill. to Boston, Mass. The inference may be made at least in part by, for example, recognizing that Chicago is a city in Illinois and that Boston is a city in Massachusetts, which recognition is made by the NL query answering system 104. Additionally, the NL query answering system 104 determines that the word “distance” is a distance measurement that, in the query, refers to the distance between the cities Chicago, Ill. and Boston, Mass. The inference also may be made at least in part by, for example, recognizing that when people ask about the distance between cities, they often do so because they will be travelling between the two cities. The inference also may be made at least in part by, for example, recognizing that when people will be travelling between two cities they often list the origin city first and the destination city second. Recognition of the words “from” and “to”, and their positions in the query with respect to the words “Chicago” and “Boston” may also be utilized to infer that the user is interested in travelling from Chicago, Ill. to Boston, Mass.

The user modeling system 120 is also configured to determine dynamically a general product or products and/or a general service or services to support the inferred activity. The user modeling system 120 is configured to determine the general product(s)/service(s) to support the inferred activity based on one or more of i) an answer generated by the NL query answering system 104, ii) curated information stored in the database 116, iii) real time information received by the user modeling system 120, etc. A general product or service is a type of product or service or category of a product or service as opposed to a specific product or service. For example, a “beverage” may be a general product, whereas a six-pack of Sprite® soft drink is a specific product that corresponds to the general product “beverage.” As another example, a “desktop computer” may be a general product, whereas specific make/model of a desktop computer is a specific product that corresponds to the general product “desktop computer.”

For example, if it is inferred that the user will hike on the Crescent Ridge trail, the user modeling system 120 is configured to determine the length of the Crescent Ridge trail, to determine a recommended amount of water to consume per distance when hiking, and to dynamically generate a suggested amount of water the user should consume while hiking the Crescent Ridge trail. For example, the user modeling system 120 may determine the length of the Crescent Ridge trail based on an answer generated by the NL query answering system 104. As an example, the user modeling system 120 may determine the suggested amount of water to consume per distance when hiking from curated information stored in the database 116. As an example, the user modeling system 120 may calculate the suggested amount of water the user should take when hiking the Crescent Ridge trail using the determined length of the Crescent Ridge trail and the determined suggested amount of water to consume per distance when hiking.

Similarly, the user modeling system 120 is configured to determine a suggested amount of calories to consume per distance when hiking, and to dynamically generate a suggested amount of calories the user should consume when hiking the Crescent Ridge trail. As an example, the user modeling system 120 may determine the suggested amount of calories to consume per distance when hiking from curated information stored in the database 116. As an example, the user modeling system 120 may calculate the suggested amount of calories the user should consume when hiking the Crescent Ridge trail using the determined length of the Crescent Ridge trail and the determined suggested amount of calories to consume per distance when hiking.

As another example, the user modeling system 120 is configured to determine current weather conditions at the Crescent Ridge trail and to determine clothing and/or accessories suitable for the weather conditions. For example, if it is raining, the user modeling system 120 is configured to determine that a rain coat and/or an umbrella are suitable clothing/accessories. As an example, the user modeling system 120 may determine current weather conditions at the Crescent Ridge trail by determining a geographic location of the Crescent Ridge trail from curated information stored in the database 116 and use the geographic location to obtain weather information corresponding to that location from an external information source (e.g., via a communication network such as the Internet). As an example, the user modeling system 120 may determine clothing and/or accessories suitable for the weather conditions based on curated information stored in the database 116.

As another example, if it is inferred that the user is travelling from Chicago, Ill. to Boston, Mass., the user modeling system 120 is configured to determine the driving distance between Chicago, Ill. and Boston, Mass., to determine a typical amount of gasoline that is consumed when driving the distance, to determine a driving route from Chicago, Ill. to Boston, Mass., and to dynamically determine one or more suggested stopping points along the driving route at which to refuel.

As discussed above, the user modeling system 120 is configured to calculate, when appropriate, an amount or degree of the general product(s)/service(s) needed to support the inferred activity, based on one or more of 1) the query, 2) an answer generated by the NL query answering system 104, 3) curated information stored in a database 116, 4) real time information received by the user modeling system 116, etc. For example, the user modeling system 120 is configured to calculate an amount of water or a number of calories to be consumed on a hike of a particular distance. As another example, the user modeling system 120 is configured to calculate an amount of fuel needed to drive a particular distance.

As discussed above, the user modeling system 120 is configured to determine, when appropriate, a location or locations at which to purchase the general product(s)/service(s), based on one or more of i) an answer generated by the NL query answering system 104, ii) curated information stored in a database 116, iii) real time information received by the user modeling system 120, etc. For example, the user modeling system 120 is configured to determine a location of where the activity will occur, a current location of the user, a location of a home of the user, a location of a place of business of the user, etc. As another example, if the activity will occur over different geographic regions (such as drive between two cities) and if the activity will require good(s)/service(s) at intervals of time or distance, the user modeling system 120 is configured to determine, when appropriate, one or more locations where the user may acquire the good(s)/service(s). For example, if the activity is a drive between two cites, the user modeling system 120 is configured to determine i) a driving route between the two cities, ii) one or more locations along the route at which the user should refuel.

The user modeling system 120 is configured to determine one or more vendors suitable for providing the general product(s)/service(s). For example, if it is inferred that the user will hike on the Crescent Ridge trail, the user modeling system 120 may determine one or more vendors near the Crescent Ridge trail, a current location of the user, a home of the user, etc., that can provide the general product(s)/service(s). As another example, if it is inferred that the user is travelling from Chicago, Ill. to Boston, Mass., and if the user modeling system 120 determined one or more suggested stopping points along the driving route at which to refuel, the user modeling system 120 may determine one or more fueling stations at or near the suggested stopping point(s).

The user modeling system 120 is communicatively coupled to product/service systems 128 of various vendors (only one system 128 is illustrated in FIG. 1 for clarity). The product/service system 128 may be coupled to a database 132 that includes commercial information regarding products/services offered by the vendor, such as pricing information, pricing models, etc. The user modeling system 120 obtains from the system 128, when appropriate, product/service information, including pricing information, for specific product(s)/service(s) that correspond to the determined general product(s)/service(s). The user modeling system 120 is configured to calculate, when appropriate, an amount of specific product(s) service(s) that corresponds to the determined amount of general product(s)/service(s) using the product/service information. For example, if it is inferred that the user will hike on the Crescent Ridge trail, the user modeling system 120 may determine a specific number of one liter bottles of water available at a particular vendor, where the number of one liter bottles corresponds to the determined amount of water that should be consumed when hiking the Crescent Ridge trail. Additionally, the user modeling system 120 may determine pricing information that corresponds to the number of one liter bottles, such as a price per bottle, a total price excluding taxes, a total price including taxes, etc.

As another example, if it is inferred that the user will hike on the Crescent Ridge trail, the user modeling system 120 may determine a specific number of energy bars available at a particular vendor, where the number of energy bars corresponds to the determined amount of calories that should be consumed when hiking the Crescent Ridge trail. Additionally, the user modeling system 120 may determine pricing information that corresponds to the number of energy bars, such as a price per bar, a total price excluding taxes, a total price including taxes, etc.

As another example, if it is inferred that the user is travelling from Chicago, Ill. to Boston, Mass., and if the user modeling system 120 determined one or more suggested stopping points along the driving route at which to refuel, the user modeling system 120 may determine an amount of fuel to refill a fuel tank. For example, the user modeling system 120 may determine the amount of fuel based on one or more of i) an average-sized fuel tank, ii) an estimated amount of fuel to required to travel to the location based on an average fuel consumption of a non-commercial vehicle, a user-specified brand/make of car, etc. The user modeling system 116 may also determine the estimated cost of re-fueling based on the determined amount of fuel and pricing information from the vendor.

In some embodiments and/or scenarios, vendor pricing information may be based on a pricing model or algorithm, and the user modeling system 120 may utilize the pricing model/algorithm to determine pricing information for the determined specific product(s)/service(s). For example, a price per unit may decrease as the number of units increases. As another example, a vendor may offer promotions such as “two-for-one” promotions on products, and the user modeling system 120 may utilize the promotional information to determine pricing information for the determined specific product(s)/service(s).

In some embodiments, the user modeling system 120 is configured to determine one or more further inferred activities and/or further general product(s)/service(s) based on one or more of previously inferred activities, previously determined general product(s)/service(s), previously determined specific product(s)/service(s), etc. For example, when it is determined that a user wishes to travel to New York City, it may be inferred that the user wishes to visit one or more destinations in New York City popular with tourists, such as the Statue of Liberty. As another example, if it is determined that the user may wish to purchase one or more data storages devices corresponding to at least a threshold amount of storage for a computer, it may be inferred that the user is interested in storing video and/or movies (and the storage devices are for storing the videos/movies). As another example, if it is determined that the user may wish to purchase three disk drives, it may be inferred that the user is interested in a network attached storage device to house at least three disk drives.

The user modeling system 120 then transmits commercial information regarding the specific product(s)/service(s) (e.g., information about the specific product/service (e.g., brand name, quantity, contact information of service provider, explanation of service, pricing information, etc.) for presentation to the user on the user device 112. In one embodiment, the user modeling system 120 transmits the information to the NL query answering system 104, which in turn transmits the information to the user device 112. In another embodiment, the user modeling system 120 is communicatively coupled to the network 108 and transmits the information to the user device 112 via the network 108.

In one embodiment, the NL query answering system 104 transmits the specific product(s)/service(s) information and pricing information along with the answer that is responsive to the NL query. For example, the specific product(s)/service(s) information and pricing information may be included in a web page that also provides the answer. In another embodiment, a web page that provides the answer to the NL query also includes a prompt asking whether the user is interested in the general product(s)/service(s). If the user responds to the prompt indicating interest, the NL query answering system 104 transmits the specific product(s)/service(s) information and pricing information to the user device 112 as another web page, for example.

In some implementations, the specific product(s)/service(s) information and pricing information is presented to the user as an advertisement of the vendor. In some implementations, the web page transmitted by the NL query answering system 104 includes specific product(s)/service(s) information and pricing information corresponding to multiple vendors.

In some embodiments, the NL query answering system 104 utilizes curated information in the database 116 to generate at least some answers to queries. In other embodiments, the NL query answering system 104 utilizes curated information in a database (not shown) separate from the database 116. In an embodiment, at least some of the information in the separate database utilized by the NL query answering system 104 is the same as information stored in the database 116. In an embodiment, at least some of the information in the curated information database 116 is copied from the separate database utilized by the NL query answering system 104, or vice versa. In an embodiment, data is copied from the separate database utilized by the NL query answering system 104 periodically, in response to changes in the database, etc.

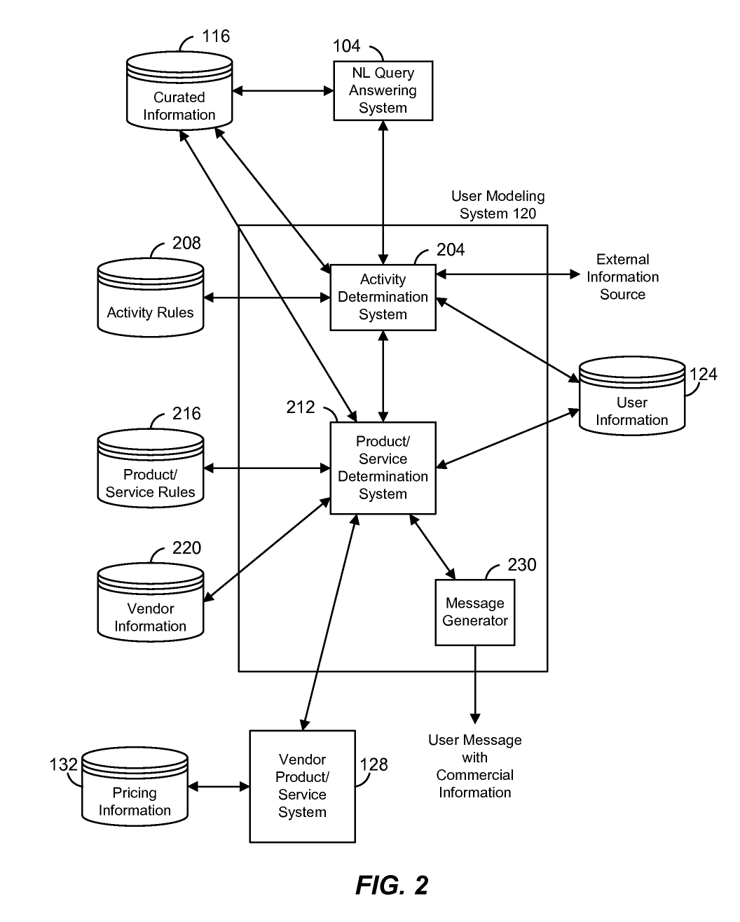

FIG. 2 is a block diagram illustrating in more detail an embodiment of the user modeling system 120. According to the illustrated embodiment, the user modeling system 120 includes an activity determination system 204 coupled to an activity rules database 208. The activity determination system 204 may also be coupled to the user information database 124, if included. The activity determination system 204 may be configured to infer an activity of the user based on 1) analyses of one or both of a) the query received by the NL query answering system 104, or b) the answer generated by the NL query answering system 104, and further based on 2) rules stored in the activity rules database 208. The activity determination system 204 also may be configured to infer an activity of the user further based on user information stored in a user information database 124.

In an embodiment, the activity determination system 204 may receive from the NL query answering system 104 information that indicates how the query was interpreted by the NL query answering system 104. For example, if the query was “what is the distance from Chicago to Boston”, the NL query answering system 104 may interpret the word “Chicago” to mean the city of Chicago, Ill., and may interpret the word “Boston” to mean the city of Boston, Mass. Further, the NL query answering system 104 may interpret the query as generally asking for the distance between two cities, and specifically the distance between Chicago, Ill. and Boston, Mass. The NL query answering system 104 may transmit indications of such interpretations to the activity determination system 204.

In other embodiments, the activity determination system 204 may include suitable natural language processing capabilities, and does not necessarily receive NL interpretation information from an outside source such as the NL query answering system 104. For example, the activity determination system 204 may include natural language processing capabilities such as described in U.S. patent application Ser. No. 11/852,044, and U.S. patent application Ser. No. 12/780,685, in one embodiment.

The activity rules database 208 may include rules that link terms and/or types of queries to activities in which the user may be interested. For example, a rule may link a query asking for the distance between two places to the activity “travel from one place to another place.” As another example, a rule may link a query asking about a place to the activity “travel to the place.” As another example, a rule may link a query asking about a thing to the activity “purchase the thing.”

In an embodiment, the activity determination system 204 may be coupled to the database 116, and the database 116 may include curated information regarding entities (e.g., people, places, things, etc.). The entity information in the database 116 may be categorized into categories, sub-categories, etc. For example, the entity “Chrysler Building” may be categorized as a place. Under the category “place,” the entity “Chrysler Building” may be sub-categorized as a “landmark,” “tourist destination,” and/or “building.” Under the sub-category “building,” the entity “Chrysler Building” may be sub-categorized as a “skyscraper.”

Additionally, the entity information in the database 116 may include characteristics and/or associated information regarding each of at least some entities. For example, for the entity “Chrysler Building,” may the entity information in the database 116 may include information related to physical characteristics (e.g., height, number of floors, rank in listing of tallest buildings in the world and/or the United States, etc.), location information (e.g., address, latitude and longitude, global positioning system (GPS) coordinates, etc.), historical information (e.g., date of completion, cost to build, etc.), current information (e.g., hours open to the public, etc.), etc. Further, information in the database 116 regarding one entity may include links and/or associations with one or more other entities that are somehow related. For example, the entity “Chrysler Building,” may include information that indicates a location in New York City, and may also be linked or associated with the entity “New York City” in the database 116.

In an embodiment, the activity determination system 204 may be configured to utilize one or more of category information, characteristic information, and links/associations with other entities in the database 116 to infer activities. For instance, there may be rules in the activity rules database 208 that specify different activities based on different entities in the database 116, the categories to which an entity belongs, characteristics about the entity, links/associations with other entities, etc.

For example, if the term “Chrysler Building” is in a query and/or answer, it may be inferred that the user wants to visit the Chrysler Building, and information in the database 116 indicates that the building is located in New York City. Thus, there may be a rule that specifies “travel to city in which entity is located,” i.e., it may be inferred that the user wants to travel to New York City. Also, there may be a rule that specifies “hotel room in city in which entity is located,” i.e., it may also be inferred that the user wants a hotel room in New York City. Similarly, there may be a rule that specifies “restaurant in city in which entity is located,” i.e., the user wants to eat a meal at a restaurant in New York City, etc. If the Chrysler Building is classified as a landmark, there may be a rule that specifies “get picture of entity,” i.e., it may also be inferred that the user wants to purchase a picture of the Chrysler Building; “visit the entity,” i.e., it may also be inferred that the user wants to visit the Chrysler Building itself; “view the entity from a vantage point,” i.e., it may also be inferred that the user wants to see the Chrysler Building from a vantage point, etc. Similarly, there may be a rule that specifies “go to restaurant proximate to entity,” i.e., it may also be inferred that the user wants to go to a restaurant near the Chrysler Building. As another example, there may be a rule that specifies “stay at hotel proximate to the entity,” i.e., it may also be inferred that the user wants a hotel room proximate to the Chrysler Building.

As an illustrative example, in response to the query “what are the tallest skyscrapers in New York City,” the answer may include the entity “Chrysler Building,” among other skyscrapers. In response to the answer, the activity determination system 204 may utilize rules in the activity rules database 208 to infer, for example, that the user wants to purchase a picture of the Chrysler Building, wants to view the Chrysler Building from a vantage point proximate to the building, wants to eat at a restaurant proximate the building, etc.

The activity determination system 204 may be coupled to the user information database 124 and may utilize information in the user information database 124 to infer activities. For example, the user information database 124 may include information indicating a location of the user. Additionally, the activity rules database 208 may include rules relating a distance between a location of the user and a location of a place-type entity to travel-type activities. For instance, there may be a rule that associates a distance between the user and a place with the inference that a user wants a hotel room. For example, a rule may specify that, when the distance between the user and the place is less than some threshold, the user is not “travelling” to the place, and the user probably does not want a hotel room. Conversely, the rule may specify that, when the distance between the user and the place is greater than the threshold, the user may be “travelling” to the place and the user may want a hotel room. Continuing with the illustrative example discussed above, if an answer includes the term “Chrysler Building,” and the user is located at least a threshold distance from New York City, it may be inferred that the user wants to travel to New York City, wants a hotel room in New York City, wants a hotel room proximate to the Chrysler Building, etc. Conversely, if the user is located less than the threshold distance from New York City, it may not be inferred that the user wants to travel to New York City, nor that the user wants a hotel room in New York City, nor that the user wants a hotel room proximate to the Chrysler Building, etc.

The activity rules database 208 may include rules that infer activities based on other inferred activities. For example, if travel to a place is inferred, there may be rules that infer purchase of products/services needed for the travel. For example, if it is inferred that a user wants to travel to a place, there may be rules that infer that the user wants to purchase transportation to the place, stay at a hotel at or near the place, eat at a restaurant at or near the place, etc. Inferred products for travel may include articles of clothing, personal products, etc. For instance, there may be rules that associate travel between different climate regions, and/or during particular times of the year, to clothing and/or personal products. As an illustrative example, if it is inferred that a user wants to travel from a coastal region of California to Chicago in December, it may be inferred that the user wants to purchase one or more of a winter hat, winter gloves, a scarf, a winter coat, etc. For instance, there may be a rule such as when travelling from a region with an average temperature (at a given time of the year) above a first threshold to a region with an average temperature below a second threshold, the user may want to purchase one or more of a winter hat, winter gloves, a scarf, a winter coat, etc. Similarly, there may be a rule such as when travelling during the winter from a Mediterranean climate region (e.g., California) to a continental region (e.g., Chicago), the user may want to purchase one or more of a winter hat, winter gloves, a scarf, a winter coat, etc. As another example, there may be a rule such as when travelling during the winter from a Mediterranean climate region (e.g., California) to a continental region (e.g., Chicago), the user may want to purchase one or more of a winter hat, winter gloves, a scarf, a winter coat, etc. As another example, there may be a rule such as when travelling to a first region when there is a relatively high probability of rain in the first region, from a second region in which the probability of rain is much lower, the user may want to purchase one or more an umbrella, a raincoat, etc. If it is known more precisely when the user is travelling to a particular destination, information from one or more external sources may be examined to determine weather information, event information, etc., that corresponds to the time of travel. For example, if it is inferred that the user wants to travel to a city on a particular day, weather forecast information from an external source may be examined to determine the weather forecast for the particular day and/or for days proximate in time to the particular day. If it is determined that rain is forecast, it may be inferred that the user may want to purchase one or more an umbrella, a raincoat, etc. Similarly, statistical weather information may be utilized such as the average temperature for a place at a particular time of the year, the chance of precipitation for a place at a particular time of the year, etc.

Similarly, event information (e.g., regarding concerts, shows, festivals, etc.) from an external source may be examined to determine the events occurring for the particular day and/or for days proximate in time to the particular day. Event information may be examined even when it is not inferred that the user wants to travel to a city on a particular day. Based on the event information, it may be inferred that the user may want to attend one or more events, etc. The information from the external sources may be obtained via the Internet or another suitable communication link, such as an extranet, a direct communication link, etc.

As another example, if it is inferred that the user wants to go to a place, and the place is categorized in the database 116 as a place of recreation, it may be inferred that the user wants to participate in a recreational activity. For example, if the place is categorized in the curated information database 116 as a hiking trail or a park with hiking trails, rules in the activity rules database 208 may specify inferences that the user wants to go hiking, buy hiking equipment, buy food/drink for the hike, etc. As another example, if the place is categorized in the curated information database 116 as a ski resort, rules in the activity rules database 208 may specify inferences that the user wants to go skiing, buy ski equipment, etc. As another example, if the place is categorized in the curated information database 116 as a golf course, rules in the activity rules database 208 may specify inferences that the user wants to go golfing, buy golfing equipment, etc.

If is determined that a term in the query and/or the answer is categorized in the curated information database 116 as computer memory, a rule in the activity rules database 208 may specify an inference that the user wants to purchase computer memory and/or computer storage. For example, a query may be “how many gigs in a terabyte”, in response to which the answer “1000 gigabytes” is generated. The term “gigabytes” may be categorized as computer memory, and a rule may specify the user activity “purchase computer memory” when the query and/or the answer includes a term classified as computer memory.

If it is determined that a term in the query and/or the answer is categorized in the curated information database 116 as data transmission rate, a rule in the activity rules database 208 may specify an inference that the user wants to purchase a network communication device such as a wireless local area network (WLAN) access point. For example, a query may be “what is data transfer time of 10 GB, 6 Mb/s”, in response to which the answer “3 hours, 42 minutes, 13.33 seconds” is generated. The term “Mb/s” may be categorized as unit of data throughput, and a rule may specify the user activity is “purchase network equipment” when the query and/or the answer includes a term classified as data throughput. Similarly, a rule may specify the user activity is “purchase data service” when the query and/or the answer includes a term classified as data throughput.

It may be determined that a term in the query and/or the answer is categorized in the curated information database 116 as astronomical (e.g., the query “star chart for northern hemisphere”, the answer is a star chart, the query “what is the closest star other than sun”, the answer is “Proxima Centauri”). A rule may specify the user activity is “purchase telescope” when the query and/or the answer includes a term classified as astronomical.

A query may be “7 day weather forecast.” In response, the NL query answering system 104 may generate answer data corresponding to a 7-day weather forecast for a location of the user. A rule may specify the user activity is “purchase rain gear” (e.g., an umbrella, a raincoat, etc.) when the forecast includes rain. A rule may specify the user activity is “purchase personal articles for snow” (e.g., gloves, a winter hat, etc.) when the forecast includes snow. A rule may specify the user activity is “purchase snow clearing equipment” (e.g., a snow shovel, a snow blower, etc.) when the forecast includes snow.

A query may be “eicosapentaenoic acid”, and the answer may include information regarding the compound eicosapentaenoic acid. The curated information database 116 may include information associating “eicosapentaenoic acid” with “dietary supplements.” A rule may specify that when a query includes a term associated with “dietary supplements,” it may be inferred that the user wants to purchase dietary supplements.

A query may be “Harvard University”, and the answer may include information regarding the well known university Harvard University. The curated information database 116 may categorize “Harvard University” as a university. A rule may specify that when a query and/or answer includes a term categorized as a “university,” it may be inferred that the user wants to purchase study aids or services related to college entrance exams.

The activity determination system 204 may be coupled to a product/service determination system 212. As discussed above, the activity determination system 204 is configured to generate indications of inferred activities of the user, and these indications may be communicated to the product/service determination system 212. The product/service determination system 212 may be configured to determine specific products/services that the user may want to purchase based on 1) the activity or activities determined by the activity determination system 204, and/or 2) rules stored in a product/service rules database 216. Additionally, the product/service determination system 212 may be configured to determine specific products/services that the user may want to purchase based on one or both of 1) the analyses of one or both of a) the query received by the NL query answering system 104, or b) the answer generated by the NL query answering system 104, and 2) information stored in the curated information database 116. The product/service determination system 212 also may be configured to products/services further based on user information stored in the user information database 124.

The product/service rules database 216 may include rules that associate activities determined by the activity determination system 204 with products and/or services. For example, a rule may link the activity “travel from one place to another place” to purchasing a plane ticket from the origin in query to the destination in query. As another example, a rule may link the activity “travel from one place to another place” to renting a car at the origin. As another example, a rule may link the activity “travel from one place to another place” to purchasing gas at waypoints along driving route from the origin in query to the destination in query. The product/service rules database 216 may include rules that associate activities determined by the activity determination system 204 with an amount of products and/or services.

The product/service determination system 212 may be coupled to a vendor information database 220. The vendor information database 220 may include information regarding vendors such as locations of the vendors, types of products/services offered by the vendors, etc. The product/service determination system 212 may be configured to determine vendors available to provide relevant products/services for activity or activities determined by the activity determination system 204 and/or corresponding to products/services determined by the product/service determination system 212. For example, if it is determined that an umbrella may be useful for a user activity, the product/service determination system 212 may be configured to utilize the vendor information 220 to determine vendors selling umbrellas proximate to a location of the user or otherwise convenient for the user. As another example, if it is inferred that the user wants to go to a place, the product/service determination system 212 may be configured to utilize the vendor information 220 to determine vendors at or proximate to the place that provide relevant products/services. For example, if it is inferred that the user wants to go to restaurants at or near the Chrysler Building, the product/service determination system 212 may be configured to utilize the vendor information 220 to determine restaurants at or proximate to the Chrysler Building. If it is inferred that the user wants to view the Chrysler Building from a vantage point, the product/service determination system 212 may be configured to utilize the vendor information 220 to determine vendors having observation decks proximate to the Chrysler Building (e.g., the Top of the Rock observation deck at Rockefeller Center.

The product/service determination system 212 may be configured to calculate, when appropriate, an amount of product(s)/service(s) for an activity or activities determined by the activity determination system 204 and/or corresponding to products/services determined by the product/service determination system 212. For example, if it is inferred that the user will go hiking, the product/service determination system 212 may calculate an amount of liquid that the user should consume while hiking. For example, if the query or the answer includes an indication of a specific hiking trail (e.g., the Crescent Ridge trail), the database 116 may be queried for a length of the trail. Additionally, the product/service rules database 216 may include a rule that indicates how much liquid a person should consume when hiking per unit of distance. The product/service determination system 212 may utilize the trail length information and the rule relating to an amount of liquid to consume when hiking to calculate an amount of liquid the user should consume when hiking the specific hiking trail.

As another example, the product/service rules database 216 may include a rule that indicates how many calories a person should consume when hiking per unit of distance. The product/service determination system 212 may utilize the trail length information and the rule relating to a number calories to consume when hiking to calculate a number of calories the user should consume when hiking the specific hiking trail.

If an amount of product/services is determined, the product/service determination system 212 may be configured to utilize information from the vendor/product service system 128 to determine a number of units of a product/service from a particular vendor that will provide the determined amount. For example, if it is determined that the user may want to consume 1 gallon of water while hiking on the Crescent Ridge trail, the product/service determination system 212 may be configured to calculate a specific number of one liter bottles of water available at a particular vendor that will provide at least 1 gallon. Additionally, the user modeling system 120 may determine pricing information that corresponds to the number of one liter bottles, such as a price per bottle, a total price excluding taxes, a total price including taxes, etc. If the vendor offers a volume discount, information regarding the volume discount may be provided to the product/service determination system 212, and the system 212 may be configured to calculate a price based on the volume discount information.

As another example, if it is determined that the user may want to consume 1000 calories while hiking on the Crescent Ridge trail, the product/service determination system 212 may be configured to calculate a specific number of energy bars available at a particular vendor that will provide at least 1000 calories. Additionally, the user modeling system 120 may determine pricing information that corresponds to the number of energy bars, such as a price per bar, a total price excluding taxes, a total price including taxes, etc.

As another example, if it is inferred that the user is travelling from Chicago, Ill. to Boston, Mass., the product/service determination system 212 may be configured to acquire a driving route from an external navigation system via the Internet or another suitable communication link or links. Additionally, the product/service rules database 216 may include a rule that indicates distance intervals at which refueling will likely be needed when driving long distances in a car. For example, the user modeling system 120 may determine the distance intervals based on one or more of i) an average-sized non-commercial vehicle fuel tank, ii) an average miles per gallon measure of a non-commercial vehicle, iii) user-specified information regarding the car to be utilized, etc.

Then, the product/service determination system 212 may be configured to determine waypoints along the driving route at which to refuel based on the determined distance intervals. Further, the product/service determination system 212 may be configured to identify gas station vendors proximate to the determined way points. Additionally, if it inferred that the user may want to stop at restaurants along the driving route, the product/service determination system 212 may be configured to identify restaurant vendors proximate to the determined way points.

In some embodiments and/or scenarios, vendor pricing information may be based on a pricing model or algorithm, and the product/service determination system 212 may be configured to utilize the pricing model/algorithm to determine pricing information for the determined specific product(s)/service(s). For example, a price per unit may decrease as the number of units increases. As another example, a vendor may offer promotions such as “two-for-one” promotions on products, and the product/service determination system 212 may be configured to utilize the promotional information to determine pricing information for the determined specific product(s)/service(s).

As discussed above, the product/service determination system 212 may be configured to determine specific pricing information for products/services provided by specific vendors. For example, after determining vendors that offer products/services that may be relevant to user activities, the product/service determination system 212 may be configured to obtain pricing information from one or more product/service systems 128 (only one illustrated in FIG. 2 for clarity) of determined vendors. As discussed above, each product/service system 128 may be coupled to a database 132 that includes commercial information regarding products/services offered by the vendor, such as pricing information, pricing models, etc. The product/service determination system 212 may be configured to obtain from the system 128, when appropriate, product/service information, including pricing information, for specific product(s)/service(s).

The user modeling system 120 may include a message generator 230 coupled to the product/service determination system 212. The message generator 230 may be configured to generate messages that communicate commercial information regarding products/services generated by the product/service determination system 212 and relating to activities inferred by the activity determination system 204 and/or the product/service determination system 212. A message generated by the message generator 230 may be configured to be displayed on a user computer as a banner, a hover ad, etc., in a web page or window generated by the NL query answering system 104, for example. As another example, a message generated by the message generator 230 may be configured to be displayed on a user computer as a pop up window. As yet another example, a message generated by the message generator 230 may be an email message, an instant message (1M), a text message, etc., addressed to the user.

The message may include an advertisement for a vendor relating to the determined products/services. The message may include information relating to a specific product/service and pricing information for the specific product/service.

The message generator 230 may be configured to dynamically create a message based on an activity inferred by the activity determination system 204 and/or the product/service determination system 212. For instance, if the query regards the Crescent Ridge trail, the message generator 230 may generate a message “Experts recommend that you drink 1 gallon of liquid while hiking the Crescent Ridge trail. 1 gallon=3.785 liters. Rob's Convenience Store is located near the Crescent Ridge trail and is selling a 6-pack of Poland Spring® ½ liter bottles of water for $15.52.” Similarly, for the same query, the message generator 230 may generate a message “We estimate that you will burn 1200 calories while hiking the Crescent Ridge trail. Rob's Convenience Store is located near the Crescent Ridge trail and is selling an 18-pack of Clif® Mini Energy Bars (total of 1800 calories) for $15.99.”

The message generator 230 may be configured to dynamically create a message based on one or more of 1) a determined product/service that supports an inferred activity of the user, 2) a determined vendor that supplies the product/service, 3) a determined quantity of units of a product/service, 4) a determined price for the product/service, 5) a pricing model received from the vendor product/service system 128, etc.

The message generator 230 may be configured to prompt the user to provide information to the user modeling system 120 prior to providing the user with commercial information. For example, the message generator 230 may be configured to prompt the user to confirm whether the user intends to perform one or more activities inferred by the activity determination system 204 and/or the product/service determination system prior to sending commercial information to the user regarding products/services related to the inferred activity. As another example, the message generator 230 may be configured to prompt the user to confirm an interest in a product/service prior to sending commercial information to the user regarding the product/service. For example, if the query and/or answer relate to the Chrysler Building and it is inferred that the user will go to the Chrysler Building in New York City, the message generator 230 may prompt the user “Are you going to visit the Chrysler Building?” via a banner, web page, etc., and may conditionally send to the user commercial information regarding restaurants proximate to the Chrysler Building based on a yes/no response to the prompt. Similarly, if the query and/or answer relate to the Chrysler Building and it is inferred that the user wants to purchase a picture of the Chrysler Building in New York City, the message generator 230 may prompt the user “Do you want to purchase a picture of the Chrysler Building?” via a banner, web page, etc., and may conditionally send to the user commercial information regarding photographs, paintings, etc., of the Chrysler Building based on a yes/no response to the prompt.

Messages generated by the message generator 230 may be transmitted to the NL query answering system 104 for inclusion in web pages, windows, etc., generated by the NL query answering system 104 and/or a client application executed on the user device 112. For example, if the NL query answering system 104 includes a generated answer in a web page, a message generated by the message generator 230 may be included in the web page by the NL query answering system 104. As another example, if the NL query answering system 104 includes a generated answer in a web page, a message generated by the message generator 230 may be included in a pop-up web page, and the web page generated by the NL query answering system 104 may be configured to cause the pop-up web page to be displayed in a pop-up browser window on the user computer. Thus, in some embodiments, messages generated by the message generator 230 may be transmitted to the user computer such that the message is not transmitted via the NL query answering system 104. As another example, a client application executed on the user computer 112 may generate a window, page, etc., using information received from the message generator 230, and the client application may be configured to cause the window, page, etc., to be displayed on the user computer 112.

A message generated by the message generator 230 may include, when appropriate, a link to permit a user to purchase product/services from a vendor. For example, a link to a vendor web site may be provided.

In some embodiments, the activity determination system 204 is configured to determine one or more further inferred activities based on one or more of previously inferred activities, previously determined general product(s)/service(s), previously determined specific product(s)/service(s), etc. For instance, the activity rules 208 may include rules that relate inferred activities to other activities. For example, there may be rule that relates the activity “travel to New York City” with the activity “visit the Statue of Liberty,” or some other popular tourist destination.

As another example, the activity rules 208 may include rules that relate inferred activities to other activities to general product(s)/service(s) determined by the product/service determination system 212. For example, there may be a rule that relates the purchase of one or more data storages devices corresponding to at least a threshold amount of storage for a computer, to the activity “storing video and/or movies” (where the storage devices are for storing the videos/movies).

As another example, the activity rules 208 may include rules that relate inferred activities to other activities to specific product(s)/service(s) determined by the product/service determination system 212. For example, there may be a rule that relates the purchase of three disk drives the activity “purchase a network attached storage device” (to house the three disk drives).

In some embodiments, the product/service determination system 212 is configured to determine one or more further general product(s)/service(s) and/or specific product(s)/service(s) based on one or more of previously determined general product(s)/service(s), previously determined specific product(s)/service(s), etc. For instance, the product/service rules 216 may include rules that relate previously determined general product(s)/service(s) to other general product(s)/service(s) and/or specific product(s)/service(s). Additionally or alternatively, the product/service rules 216 may include rules that relate previously determined specific product(s)/service(s) to other general product(s)/service(s) and/or specific product(s)/service(s). For example, there may be a rule that relates the general product “plane ticket” to the general product “travel insurance.” As another example, there may be a rule that relates the specific product “iPad” to the general product “tablet computer stand.”

In one embodiment, the NL query answering system 104, the activity determination system 204, the product/service determination system 212, and the message generator 230 are implemented by discrete server systems. In this embodiment, information communicated amongst the NL query answering system 104, the activity determination system 204, the product/service determination system 212, and the message generator 230 may be transmitted via suitable communication links such as one or more of an intranet, an extranet, the Internet, point-to-point links, etc. In other embodiments, one or more of the NL query answering system 104, the activity determination system 204, the product/service determination system 212, and the message generator 230 may be implemented by a common server system. As one example, the NL query answering system 104 may be implemented by a first server system, and the user modeling system 120 may be implemented by a second server system. As another example, the NL query answering system 104 may be implemented by a first server system, the activity determination system 204 may be implemented by a second server system, and the product/service determination system 212 and the message generator 230 may be implemented by a third server system. As yet another example, the NL query answering system 104 may be implemented by a first server system, the activity determination system 204 and the product/service determination system 212 may be implemented by a second server system, and the message generator 230 may be implemented by a third server system. As yet another example, the NL query answering system 104, the activity determination system 204, and the product/service determination system 212 may be implemented by a first server system, and the message generator 230 may be implemented by a second server system.

Similarly, in some embodiments, the curated information database 116, the user information database 124, the activity rules database 208, the product/service rules database 216, and the vendor information database 220 are implemented by discrete database systems. In other embodiments, one or more of the curated information database 116, the user information database 124, the activity rules database 208, the product/service rules database 216, and the vendor information database 220 may be implemented by a common database system. As just one example, the activity rules database 208 and the product/service rules database 216 may be implemented as a common database system. As another example, the curated information database 116 and the activity rules database 208 may be implemented as a common database system.

Other variations will be apparent to those of ordinary skill in the art in light of the present disclosure.

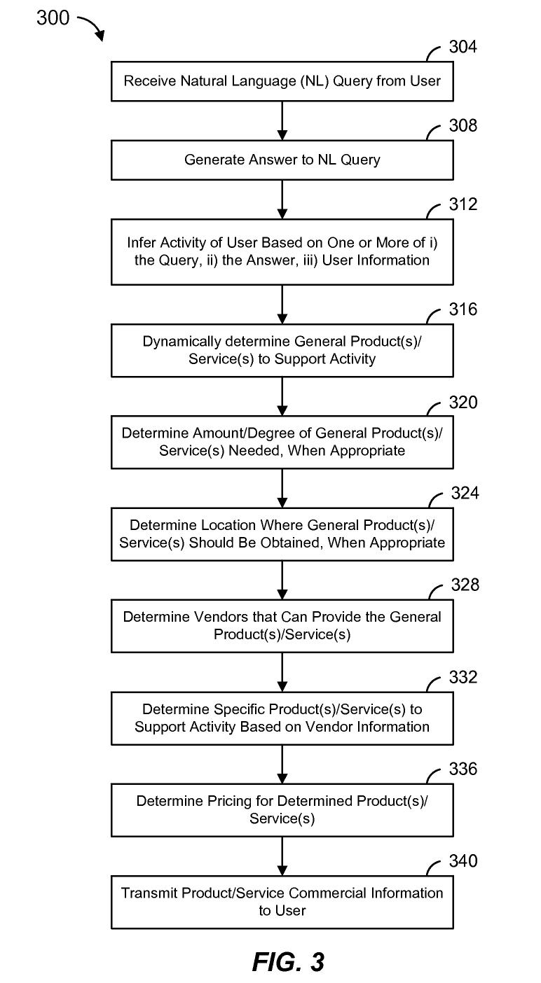

FIG. 3 is a flow diagram of an example method 300 for providing commercial information regarding products/services to a user. The method 300 may be implemented in the system 100 of FIG. 1 and/or the system 200 of FIG. 2, and will be discussed with reference to FIGS. 1 and 2 for ease of explanation. It will be apparent in light of the present disclosure, however, that the method 300 may be implemented by other suitable systems and/or that the system 100 of FIG. 1 and/or the system 200 of FIG. 2 may implement suitable methods other than the method 300.

At block 304, a natural language (NL) query may be received from a user. For example, the NL query may be entered into a text box of a web page, a window, etc., displayed on the user computer 112, and then the NL query may be electronically transmitted to the NL query answering system 104 and/or the user modeling system via the network 108. At block 308, an answer to the NL query may be generated. For example, the NL query answering system 104 may generate the query. Example techniques for generating answers to NL queries are found in U.S. patent application Ser. No. 11/852,044 and U.S. patent application Ser. No. 12/780,685. Other suitable techniques for generating answers to NL queries may also be used.

At block 308, an activity of the user is inferred based on one or more of i) the query received by the NL query answering system 104, ii) the answer generated by the NL query answering system 104, or iii) user information. Block 308 may be implemented by the user modeling system 120. For example, block 308 may be implemented by the activity determination system 204 utilizing rules stored in the activity rules database 208 and/or based on user information stored in the user information database 124. User information may also be received from the user computer 112 or some other computing system. For example, a web page, window, etc., displayed on the user computer 112 may prompt the user to provide user information (e.g., user preferences, an indication of a location of the user, etc.), and the user information may be transmitted to the user modeling system 120 (e.g., by way of the NL query answering system 104 or bypassing the NL query answering system 104). As another example, if the user computer 112 includes a positioning system (e.g., a global positioning satellite (GPS) system), position information generated by the positioning system may be transmitted to the user modeling system 120.

In some embodiments, block 308 includes, after inferring one or more first activities, inferring one or more second activities based on the one or more first activities. For example, if travel to a city is inferred, it may be inferred that the user wants to visit sights of general interest in the city, such as popular tourist destinations. For example, if it is inferred that a user wants to travel to a New York City, there may be rules that infer that a user who is visiting New York City wants to visit the Statue of Liberty.

Example techniques for inferring an activity of a user are discussed above. Additionally, other suitable techniques (apparent in light of the present disclosure) for inferring an activity of the user may be utilized.

At block 316, general products/services to support the activity are dynamically determined. Block 316 may be implemented by the user modeling system 120. For example, block 316 may be implemented by the activity determination system 204 utilizing rules stored in the activity rules database 208 and/or by the product/service determination system 212 using rules stored in the product/service rules database 216. For example, if it is determined that the activity is “go to a place”, it may be determined that the user may want to purchase a plane ticket, rent a car, buy gas, stay at a hotel, go to a restaurant, purchase clothing suitable for the place and/or for weather associated with the place, etc., based on rules stored in the activity rules database 208 and/or the product/service rules database 216. Example techniques for dynamically determining general products/services to support the activity are discussed above. Additionally, other suitable techniques (apparent in light of the present disclosure) for dynamically determining general products/services to support the activity may be utilized.

At block 320, amounts/degrees of products/services that are needed may be dynamically determined, when appropriate. The user modeling system 120 may be configured to calculate, when appropriate, an amount or degree of a product/service needed to support an inferred activity based on one or more 1) the query, 2) an answer generated by the NL query answering system 104, 3) curated information stored in the database 116, 4) real time information received by the user modeling system 120, etc. For example, the product/service determination system 212 may calculate an amount or degree of a product/service needed to support an inferred activity utilizing rules in the product/service rules database 216 and based on one or more 1) the query, 2) an answer generated by the NL query answering system 104, 3) curated information stored in the database 116, 4) real time information received by the product/service determination system 212, etc. Example techniques for determining amounts/degrees of products/services are discussed above. Additionally, other suitable techniques (apparent in light of the present disclosure) for determining amounts/degrees of products/services may be utilized.

At block 324, location(s) at which products/services should be obtained are determined, when appropriate. The locations may be determined based on one or more of 1) the query, 2) an answer generated by the NL query answering system 104, 3) curated information stored in the database 116, 4) information indicating a location of the user, etc. The user modeling system 120 may be configured to determine locations based on one or more 1) the query, 2) an answer generated by the NL query answering system 104, 3) curated information stored in the database 116, 4) information indicating a location of the user, etc. For example, the product/service determination system 212 may be configured to determine locations based on one or more 1) the query, 2) an answer generated by the NL query answering system 104, 3) curated information stored in the database 116, 4) information indicating a location of the user, etc. Example techniques for determining locations at which products/services should be obtained, when appropriate, are discussed above. Additionally, other suitable techniques (apparent in light of the present disclosure) for determining amounts/degrees of products/services may be utilized.

At block 328, vendors that provide products/services are determined based on the products/services determined at block 316 and, when appropriate, the locations determined at block 324. The user modeling system 120 may be configured to determine vendors that provide appropriate products/services. For example, the product/service determination system 212 may be configured to determine vendors that provide appropriate products/services using information stored in the vendor information database 120. Example techniques for determining determine vendors that provide appropriate products/services are discussed above. Additionally, other suitable techniques (apparent in light of the present disclosure) for determining vendors that provide appropriate products/services may be utilized.

At block 332, specific products/services to support the inferred activities are determined based on 1) the products/services determined at block 316, the amount/degree determined at block 320, when appropriate, and 3) the vendors determined at block 328. The user modeling system 120 may be configured to determine specific products/services to support the inferred activities. For example, the product/service determination system 212 may be configured to specific products/services to support the inferred activities by communicating with one or more vender product/service systems 128. Example techniques for determining specific products/services to support the inferred activities are discussed above. Additionally, other suitable techniques (apparent in light of the present disclosure) for determining specific products/services to support the inferred activities may be utilized.

At block 336, pricing for the products/services (determined at block 332) may be determined, when appropriate. The user modeling system 120 may be configured to determine pricing for products/services when appropriate. For example, the product/service determination system 212 may be configured to determine pricing for products/services by communicating with one or more vender product/service systems 128. Example techniques for determining pricing for specific products/services are discussed above. Additionally, other suitable techniques (apparent in light of the present disclosure) for determining pricing for specific products/services may be utilized.

In some embodiments, one or more of blocks 312, 316, 320, 324, 328, 332 and 336, or similar blocks, are implemented multiple times and/or iteratively implemented based on one or more of previously determined inferred activities, general products/services, specific products/services, etc. For example, additional inferred activities may be determined based on one or more of previously determined inferred activities, general products/services, specific products/services, etc. Similarly, additional general products/services may be determined based on one or more of previously determined general products/services, specific products/services, etc. Similarly, additional specific products/services may be determined based on one or more of previously determined general products/services, specific products/services, etc.

At block 340, commercial information related to product/services determined at block 332 may be transmitted to the user. The commercial information may include one or more of 1) information regarding vendors determined at block 328 (e.g., name, location, contact information, links to vendor web sites, etc.), 2) indications of products/services determined at block 332, and 3) pricing information determined at block 336. The user modeling system 120 may be configured to transmit the commercial information to the user computer 112. For example, the message generator 230 may be configured to transmit the commercial information to the user computer 112. Example techniques for generating and transmitting messages including commercial information related to products/services are discussed above. Additionally, other suitable techniques (apparent in light of the present disclosure) for generating and transmitting messages including commercial information may be utilized.

In other embodiments, the user modeling system 120 is not coupled to an NL query answering system such as described above. Rather, in some embodiments, the user modeling system 120 is coupled to another type of query answering system such as Internet search system, etc. In some embodiments, NL analysis techniques and/or systems similar to the NL analysis techniques and systems described in U.S. patent application Ser. No. 11/852,044 and/or U.S. patent application Ser. No. 12/780,685 are utilized by the user modeling system 120 to analyze a query submitted to the query answering system. In other embodiments, other suitable NL analysis systems are utilized.

Each of the server systems described above may be implemented by a single server devices or a plurality of server devices communicatively coupled together. Each server device may comprise a processor configured to execute machine readable instructions stored in a computer readable storage medium (e.g., a magnetic or optical disk, a FLASH memory, a random access memory (RAM), a read only memory (ROM), etc.) coupled to the processor. While methods and systems have been described herein as being implementable by a processor that executes software and/or firmware instructions stored in a memory coupled to the processor, they also may be implemented in hardware, and may be implemented by a variety of computing systems and devices. Thus, the method blocks and system blocks described herein may be implemented using a standard multi-purpose central processing unit (CPU), a special purpose CPU, or on specifically designed hardware such as an application-specific integrated circuit (ASIC), a custom integrated circuit (IC), a programmable logic device (PLD), etc., or other hard-wired device as desired. When implemented using a processor that executes software and/or firmware instructions, the software/firmware may be stored in any computer readable storage medium such as on a magnetic disk, an optical disk (such as a compact disk (CD), a digital versatile disk (DVD)), a FLASH memory, a memory card, a memory stick, in a RAM or ROM of a computer or processor, in any database, etc., or other storage medium. Likewise, this software may be delivered via any known or desired delivery method including, for example, on a computer readable memory or other transportable computer storage mechanism or over a communication channel such as a telephone line, the internet, etc.

The present disclosure has been described with reference to specific examples, which are intended to be illustrative only and not to be limiting. It will be apparent to those of ordinary skill in the art that changes, additions or deletions may be made to the disclosed examples without departing from the spirit and scope of the disclosure.

What is claimed is:

1. A method in a computing system for providing to a user commercial information regarding at least one of a product or a service, the method comprising the acts of:
analyzing, using the computing system, a query of the user electronically received via a network;
inferring, using the computing system, an activity of the user based on the analysis of the query;
determining, using the computing system, a general product or service to support the activity;
determining, using the computing system and in response to determining the general product or service, a vendor that provides the general product or service;
electronically obtaining, using the computing system, information regarding a specific product or service provided by the vendor, wherein the specific product or service corresponds to the general product or service; and
generating, using the computing system, commercial information corresponding to the specific product or service provided by the vendor, wherein the commercial information is for electronic transmission to the user.

2. A method according to claim 1, further comprising analyzing, using the computing system, an answer to the query, wherein the answer has been generated using a query answering computing system;
wherein inferring the activity is further based on the analysis of the answer to the query.

3. A method according to claim 2, further comprising:
electronically receiving the query at the query answering computing system; and
generating, using the query answering computing system, the answer to the query.

4. A method according to claim 1, wherein obtaining the information regarding the specific product or service includes electronically communicating with a vendor computing system that provides information regarding products or services of the vendor.

5. A method according to claim 4, further comprising determining, using the computing system and based on the inferred activity, a location at which to obtain the product or service;
wherein determining the vendor is based on the determined location.

6. A method according to claim 1, further comprising:
calculating, using the computing system, an amount or degree of the specific product or service based on the inferred activity; and
calculating, using the computing system, a number of units of the determined product or service based on the calculated amount or degree;
wherein the commercial information includes the calculated number of units.

7. A method according to claim 6, further comprising calculating, using the computing system, a price for the determined number of units of the specific product or service;
wherein the commercial information includes the calculated price.

8. A method according to claim 6, further comprising electronically receiving a pricing model;
wherein calculating the price comprises calculating the price according to the pricing model.

9. A system for providing product and/or service information to a user, comprising:
a user modeling system configured to:
analyze a query of the user electronically received via a network,
infer an activity of the user based on the analysis of the query,
determine a general product or service to support the activity,
determine, in response to determining the general product or service, a vendor that provides the general product or service,
electronically obtain information regarding a specific product or service provided by the vendor, wherein the specific product or service corresponds to the general product or service, and
generate commercial information corresponding to the specific product or service provided by the vendor, wherein the commercial information is for electronic transmission to the user.

10. A system according to claim 9, further comprising:
a query answering computing system configured to:
receive the query, and
generate an answer to the query; and
wherein the user modeling system is configured to:
analyze the answer to the query, and
infer the activity further based on the analysis of the answer to the query.

11. A system according to claim 9, wherein the user modeling system is configured to electronically obtain the information regarding the specific product or service provided by the vendor from a vendor computing system information.

12. A system according to claim 11, wherein the user modeling system is configured to determine a location at which to perform the activity;
wherein the user modeling system is configured to determine the vendor based on the determined location.

13. A system according to claim 9, wherein the user modeling system is configured to calculate, in response to determining the specific product or service, a price for the determined specific product or service using a pricing model;
wherein the commercial information includes the calculated price.

14. A tangible computer readable storage medium having stored thereon machine executable instructions, the machine executable instructions capable of causing, when executed by one or more processors, the one or more processors to:
analyze a query of the user electronically received via a network;
infer an activity of the user based on the analysis of the query;
determine a general product or service to support the activity;
determine, in response to determining the general product or service, a vendor that provides the general product or service;
electronically obtain information regarding a specific product or service provided by the vendor, wherein the specific product or service corresponds to the general product or service; and
generate commercial information corresponding to the specific product or service provided by the vendor, wherein the commercial information is for electronic transmission to the user.

15. A method in a computing system for providing product and/or service information to a user, the method comprising the acts of:
analyzing, using the computing system, an answer to a query submitted to a query answering system, wherein the answer has been generated using the query answering computing system;
inferring, using the computing system, an activity of the user based on the analysis of the answer to the query;
determining, using the computing system, a general product or service to support the activity;
determining, using the computing system and in response to determining the general product or service, a vendor that provides the general product or service;
electronically obtaining, using the computing system, information regarding a specific product or service provided by the vendor, wherein the specific product or service corresponds to the general product or service; and
generating, using the computing system, commercial information corresponding to the specific product or service provided by the vendor, wherein the commercial information is for electronic transmission to the user.

16. A method according to claim 15, further comprising:
electronically receiving the query at the query answering computing system; and
generating, using the query answering computing system, the answer to the query.

17. A method according to claim 15, wherein obtaining the information regarding the specific product or service includes analyzing electronically communicating with a vendor computing system that provides information regarding products or services of the vendor.

18. A method according to claim 17, further comprising determining, using the computing system and based on the inferred activity, a location at which to obtain the general product or service;
wherein determining the vendor is based on the determined location.

19. A method according to claim 15, further comprising:
calculating, using the computing system, an amount or degree of the specific product or service based on the inferred activity; and
calculating, using the computing system, a number of units of the determined product or service based on the calculated amount or degree;
wherein the commercial information includes the calculated number of units.

20. A method according to claim 19, further comprising calculating, using the computing system, a price for the determined number of units of the specific product or service;
wherein the commercial information includes the calculated price.

21. A system for providing product and/or service information to a user, comprising:
a user modeling system configured to:
analyze an answer to a query submitted to a query answering system, wherein the answer has been generated using the query answering computing system,
infer an activity of the user based on the analysis of the answer,
determine a general product or service to support the activity,
determine, in response to determining the general product or service, a vendor that provides the general product or service,
electronically obtain information regarding a specific product or service provided by the vendor, wherein the specific product or service corresponds to the general product or service, and
generate commercial information corresponding to the specific product or service provided by the vendor, wherein the commercial information is for electronic transmission to the user.

22. A system according to claim 21, further comprising:
a query answering computing system configured to:
receive the query, and
generate the answer to the query.

23. A tangible computer readable storage medium having stored thereon machine executable instructions, the machine executable instructions capable of causing, when executed by one or more processors, the one or more processors to:
analyze an answer to a query submitted to a query answering system, wherein the answer has been generated using the query answering computing system;
infer an activity of the user based on the analysis of the answer;
determine a general product or service to support the activity;
determine, in response to determining the general product or service, a vendor that provides the general product or service;
electronically obtain information regarding a specific product or service provided by the vendor, wherein the specific product or service corresponds to the general product or service; and
generate commercial information corresponding to the specific product or service provided by the vendor, wherein the commercial information is for electronic transmission to the user.
